(19) United States
(12) Patent Application Publication
(10) Pub. No.: US 2025/0091484 A1
(43) Pub. Date: Mar. 20, 2025

(54) VEHICLE SEAT FOR A VEHICLE

(71) Applicant: Faurecia Autositze GmbH, Hannover (DE)

(72) Inventors: Przemyslaw ADAMCZYK, Grójec (PL); Grzegorz WOJTOWICZ, Auburn Hills, MI (US); Carlo ESCUTIA, Auburn Hills, MI (US); Krzysztof POLAKOWSKI, Grójec (PL); Mateusz MARCINKOWSKI, Wola Wysoka (PL)

(21) Appl. No.: 18/890,377

(22) Filed: Sep. 19, 2024

(30) Foreign Application Priority Data
Sep. 19, 2023 (DE) 10 2023 125 397.2

(51) Int. Cl. B60N 2/02; B60N 2/10; B60N 2/16

(52) U.S. Cl. CPC B60N 2/02253; B60N 2/10; B60N 2/164

(57) ABSTRACT

A vehicle seat for a vehicle, the vehicle seat having: a first seat part, being adjustable relative to a second seat part, an adjusting device, configured to adjust the first seat part relative to the second seat part, and an electromotive drive for driving the adjusting device. The adjusting device includes a spindle shaft, a threaded nut received on the spindle shaft, an outer profile, and an inner profile. The inner profile is longitudinally adjustably received in the outer profile, and one of the profiles is connected with the spindle shaft and the other profile with the threaded nut. The profiles are closed or open, with sliding bushings being provided between the profiles.

### TECHNICAL FIELD

The invention relates to an adjustable vehicle seat in particular, for a motor vehicle.

### BACKGROUND

Generally, vehicle seats are provided with several means of adjustment. Thus, generally, a longitudinal adjustment of the vehicle seat in the vehicle is provided, in particular, via upper tracks which are adjusted on lower tracks mounted on the floor. Furthermore, the seat height of the seat cushion may be adjusted in relation to the floor or the track system respectively, as well as, e.g., the seat inclination or, respectively, inclination of the seat cushion in relation to the floor or the track system. Motorized adjustment means provide higher comfort to the user, but they may lead, inter alia, to package problems in the placement of the electric motor. Hereby, various motorized adjustment means are known, e.g., including tumble gears, scissor systems, as well as spindle drives, where a threaded nut is longitudinally adjusted on a threaded rod or spindle shaft respectively. The spindle shaft is in particular a thread leadscrew.

The document U.S. Pat. No. 2,765,024 A describes a seat adjustment mechanism including actuators arranged opposite one another for longitudinal adjustment of the vehicle seat, where each actuator comprises elongated tube having a first collar formed with an internal annular groove, where a shaft extending through the first collar into the tube, a gearing formed on the shaft, and a coupling means between the shaft and the first collar is adjustably mounted on the threading. Hereby, a motorized adjustment of two opposite adjusting devices is provided.

The citation U.S. Pat. No. 3,043,551 A shows a vehicle seat adjusting mechanism comprising a base support, a seat support, and a spaced pair of seat adjusting means, each pivotally secured to said base support and to said seat support, the pair of pivotal axes of one of said adjusting means being located in spaced parallel relationship, and the pair of pivotal axes of the other of said seat adjusting means being oriented perpendicular to one another.

From the document DE 100 00 906 C1 a motor vehicle seat is known with a frame element comprising a spindle drive with a spindle as well as a spindle not cooperating with the spindle, where the spindle drive engages with the frame element and allows for various adjustment positions. Hereby, the spindle is encased at least in part by a securing element allowing for securing the spindle drive against buckling of the spindle otherwise possible in a crash. The securing element is designed, in particular, as a securing sleeve encasing the spindle drive at least over a part of its length.

Generally, adjustment means of this type are relatively complex and require corresponding mounting space for the adjustment mechanism as well as the electromotive drive. Also, the individual elements of the adjusting device must be dimensioned with sufficient strength to withstand occurring loads, in particular, bending moments and forces.

The document EP 2 985 174 A1 shows a sliding means for a vehicle seat with a lower track for mounting on a vehicle floor and an upper track mounted on the underside of a seat part, where a friction reducing element is arranged between the two tracks which comprises slide contact parts which in tun comprise multiple parts.

From the citation WO2016/059108 A1 a linear motor design as well as a slide part for use in the linear motor design are known, where a first receiver is attached to a seat and a second receiver is attached to a surface, the two receivers being adjustable in relation to one another in a longitudinal direction and a slide part is provided between the receivers, the slide part having a material exhibiting low friction.

The document DE 25 49 711 A1 describes a mounting for a slidable vehicle seat consisting of guide tracks affixed to the vehicle and of sliding tracks affixed to the seat, where the sliding tracks are slidable, with plastic sliding members placed in-between, along the guide tracks, and where the guide tracks each exhibit a U profile open at the top.

The citation DE 10 2011 081 107 A1 describes an adjustment means for adjusting an adjustment part of a vehicle including a first and second guide track mounted such that they are slidable in relation to one another in a longitudinal direction and each have a base and at least one arm projecting from the base and an edge section, with bearing elements being provided in the area of the edge sections.

From the citation DE 10 2014 219 206 A1 a transport seat is known having two lower and two upper tracks each being slidingly joined, where an electric drive mechanism and two mountings as well as two buffer elements are provided. The two buffer elements are arranged between the upper surface of an upper track and the corresponding mounting, where the electric drive mechanism drives a shaft and threaded spindles for a relative adjustment.

The document DE 10 2019 120 914 A1 describes a seat track mechanism for a vehicle, the seat track mechanism being provided for installation below a vehicle seat and for adjustment in a forwards and backwards direction and comprising a single seat track mechanism with hook guides for attachment.

The document DE 10 2021 214 947 A1 describes a slide block for a pair of seat tracks of a longitudinal adjustment mechanism including a base part having a lower and upper sliding surface, where one of the sliding surfaces is fixed and the other sliding surface is designed to be fixed and/or flexible differing in different regions.

In the citation DE 10 2015 112 029 A1 a vehicle seat is shown comprising a floor anchoring, a seating surface and a back part, where at least two adjusting elements modifiable in length are provided between the floor anchoring and the seating surface.

From the document U.S. Pat. No. 2,765,024 A a vehicle seat adjustment mechanism is known comprising a base support, a seat support and a spaced-apart pair of seat adjusting means each pivoting mounted on the base support and the seat support, where one pair of pivot axes of one of the adjusting means is mounted spaced apart and parallel to the pair of pivot axes of the other adjusting means.

The document U.S. Pat. No. 6,637,816 B2 describes a seat system including a deceleration sensor sensing a deceleration or braking of the vehicle. Hereby, a swivel mechanism for picoting the seat arrangement is provided, where a controller unit is connected with the deceleration sensor and is capable of actuating a swivel mechanism depending on a detected deceleration event.

The citation KR 20-0440263 Y1 describes a further adjustable vehicle seat.

### SUMMARY

It is an object of the invention to create an adjustable vehicle seat for a vehicle allowing for a secure adjustment and high stability requiring little effort and small mounting space.

This task may be solved by a vehicle seat according to claim 1. Advantageous further developments are described in the sub-claims.

The vehicle seat comprises at least one motorized adjusting device including a spindle drive with a spindle threaded rod respectively, a spindle nut received on the spindle as well as two profiles. the two profiles are placed inside one another and can be adjusted by the spindle drive in their longitudinal direction relative to each other. Sliding bushings are provided in-between the two profiles.

This creates and adjustment means which is, for one thing, is highly space-saving and, for another, can be realized at low cost. The two profiles placed inside one another allow for a telescopic adjustment in a longitudinal direction or axial direction respectively of the profiles, where, preferably, the spindle is received in the inner profile so as allow for a highly compact design. Preferably, what is formed is a design with an outer profile, an inner profile received in the outer profile via the sliding bushings, and the spindle received in the inner profile.

Thus, this design is compact and space-saving, moreover, it can be manufactured at low cost and with little effort. Further, it can withstand high adjusting forces because a longitudinal adjustment of the two profiles in relation to one another is provided without or, respectively, without relevant moments and bending forces between the profiles. Thus, the adjusting device is rigid and in principle requires no further stiffening elements in addition to the two profiles. Also, the adjusting device can be connected relative easily with little effort in that the two seat parts of the vehicle seat to be adjusted are connected with their profiles directly or indirectly via further means such as, e.g., joints.

The electromotive drive is preferably provided outside the profiles and comprises, in particular, an electric motor and a downstream transmission. Thus, the profiles may be designed sufficiently rigid, compact and narrow without housing the electric motor. The transmission preferably allows for a suitable support of the electric motor. Preferably a gearbox or, respectively, a housing of the transmission means is connected directly to one of the profiles thereby forming a fixed unit so that a fixed unit is formed made of the adjusting device, the gearbox housing and a support, e.g., cross bar, receiving the motor, which unit can be mounted in the vehicle seat at one of the two seat parts to be adjusted. Correspondingly, the other of the two profiles can be mounted on the other seat part so that by longitudinally adjusting the two profiles in relation to one another suitable adjustments of the seat parts or seat elements respectively can be made, e.g., a linear adjustment or even swiveling adjustment of the seat parts in relation to one another.

Advantageously, the threaded nut received on the drive is received directly in a fixed manner, in particular, by positive locking and/or by crimping, in one of the profiles, in particular, the outer profile, so that rotating the spindle shaft directly causes a translational longitudinal adjustment of this profile together with the threaded nut.

A further advantage lies in the simple and secure realizability of the bearing between the individual components, in particular, in-between the profiles. Thus, advantageously, no complex ball bearings or roller bearings with additional elements and high expenses are required. The direct longitudinal adjustment, without or, respectively, without relevant bending moments and torsional forces, allows for simple sliding bushings to be provided in-between the profiles. The two profiles may be designed with a suitable fit so that, e.g., one or more sliding bushings each are provided merely in front and a rear bearing point or area respectively which can securely absorb the forces occurring in a longitudinal direction. Such sliding bushings have cost advantages in relation to ball bearings and further can be easily mounted and exhibit high durability.

The two profiles may be designed closed, thereby being stiffer and providing better protection of the interior space, where, in that case, they allow, e.g., sliding bushings made of plastics to be utilized; further, open profiles may also be provided, thereby requiring less material and allowing for better access to the interior space.

The motor including the motor shaft may be provided, in particular, in total or essentially perpendicular or, respectively, orthogonal to the longitudinal axis of the adjusting device and thereby perpendicular to the spindle axis. This allows the electric motor including the receiving support to be mounted in a suitable location in the motor vehicle seat. Thus, in the case of a track system, for longitudinal adjustment of the vehicle seat the cross bar including the electric motor may be provided below the seat cushion thereby no longer affecting the narrow building space in the area of the track system. In the case of other adjustment means too the cross bar including the electric motor may be provided, e.g., under the seat cushion or, respectively, in another suitable location of one of the adjustable seat parts.

Furthermore, the perpendicular connection of the motor with the motor shaft to the adjusting device also allows for a design having a common electric motor for two parallel adjusting devices which, thereby, allow for a secure adjustment parallel to one another, in particular, at a left side and right side of the vehicle seat. Thus, for all adjusting means two parallel adjusting devices each with a common electric motor may be provided. This advantageously forms a motor bridge interconnecting the two adjusting devices formed parallel to one another and spaced apart thereby forming a compact unit.

As an alternative, a single-track solution is provided, wherein, thus, a single adjusting device with exactly one pair of profiles is provided

A further advantage lies in the modular design or, respectively, the broad usability of the adjusting device for different adjusting means so that equal or, respectively, equivalent adjusting devices may be mounted at various locations in the vehicle seat.

The adjusting devices may serve, in particular, for
longitudinal adjustment of upper tracks in relation to lower tracks,
height adjustment or tilt adjustment of a seat cushion in relation to the track system or the upper tracks respectively, as well as
adjustment of a foot rest in relation to the seat cushion.

Furthermore, the spindle drive allows for a self-locking adjustment thereby providing a high degree of safety.

The adjustment of the seat cushion in relation to the track system or the vehicle floor may be carried out, in particular, by means of a pair of front adjusting devices and a pair of rear adjusting devices. This arrangement allows, for one thing, for an inclination adjustment or, respectively a pivoting of the seat cushion in relation to the track system in that the front and rear adjusting devices are actuated differently. Thus, e.g., only the two front adjusting devices may be extended so as to pivot the vehicle seat backwards, and, correspondingly, only the rear adjusting devices may be extended to pivot the vehicle seat forward. Furthermore, this allows for a adjustment by simultaneous actuation of the front and rear adjusting devices.

### BRIEF DESCRIPTION OF THE DRAWINGS

The invention is illustrated below by means of the accompanying drawings by means of a few embodiment examples. It is shown in:

FIG. 1—a vehicle seat in a default position in a lateral view;

FIG. 2—the vehicle seat in a comfort position tilted back;

FIG. 3—the vehicle seat from FIG. 1 in comfort position tilted forward;

FIG. 4—the longitudinal adjustment of the vehicle seat on lower tracks;

FIG. 5—the adjustment of a foot rest of the vehicle seat;

FIG. 6—the adjusting means in the retracted state of the profiles;

FIG. 7—the adjusting system with two lateral adjusting devices and a middle motor according to an embodiment in a perspective bottom view;

FIG. 8—the adjusting system from FIG. 7 in a perspective top view;

FIG. 9—a section through the adjusting system in the region of the spindle shaft;

FIG. 10—a bottom view of the adjusting system with two lateral adjusting devices;

FIG. 11—a rear view of the adjusting system;

FIG. 12—a longitudinal section through an adjusting device in the retracted state;

FIG. 13—a section perpendicular through the longitudinal axis of the adjusting device;

FIG. 14—an adjusting system with a motor and only one adjusting means;

FIG. 15—a representation of the retracted adjusting device as well as an exploded view of the adjusting device.

FIGS. 16 through 22 show a further embodiment of the adjusting system with two lateral adjusting devices and a middle motor in various views:

FIG. 16—the adjusting system in a perspective top view, corresponding to FIG. 8;

FIG. 17—the adjusting system in a perspective bottom view, corresponding to FIG. 7;

FIG. 18, 19—lateral views of the adjusting system from FIGS. 16, 17;

FIG. 20—the adjusting system from FIGS. 16 through 19 in a bottom view;

FIG. 21—a front view of the adjusting system;

FIG. 22—a top view on the adjusting system.

### DETAILED DESCRIPTION

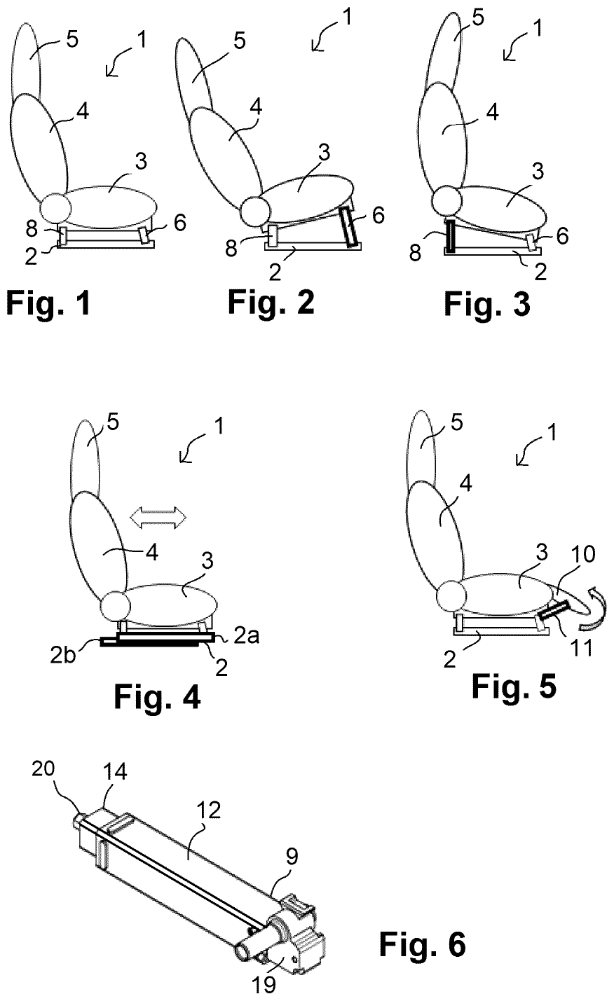

A vehicle seat 1 comprises multiple seat parts which can be adjusted relative to one another by various adjusting means. FIG. 1 shows the vehicle seat 1 in its default position, with a longitudinal track system 2, a seat cushion 3, a backrest 4 and a headrest 5. The vehicle seat 1 shown in FIG. 1 can be adjusted, in principle, in various ways, as will be described in connection with FIGS. 2 through 5. For one thing, the seat cushion 3 can be inclination adjusted or swiveled respectively in relation to the longitudinal track system 2; to that end, two front adjusting devices 6, i.e., as front feet, and two rear adjusting devices 8, i.e., as rear feet, are provided between the seat cushion 3 and the longitudinal track system 2 or, respectively, the upper track 2a of the longitudinal track system 2. Thus, in particular, in the lateral views of FIGS. 1 through 5 the respective right adjusting device 6, 8 is shown. According to FIG. 2, the vehicle seat 1 is tilted back by adjustment of the front adjusting devices 6 in that these are telescopically expanded. Accordingly, the vehicle seat 1 according to FIG. 3 is tilted forward by adjustment of the rear adjusting devices 8 which in turn are telescopically expanded. Accordingly, the vehicle seat 1 can be height adjusted by actuating both the front adjusting devices 6 and the rear adjusting devices 8, without incline adjustment or, respectively, with superimposed incline adjustment.

FIG. 4 shows the longitudinal adjustment of the vehicle seat 1, where the upper tracks 2a are adjusted in relation to the lower tracks 2b mounted on the floor of the vehicle by means of adjusting devices, not shown in greater detail here, provided directly on or in the longitudinal track systems. FIG. 5 shows an adjusting means of a foot rest 10 by means of a separate foot rest adjusting device 11 provided between the foot rest 10 and the seat cushion 3. Thus, it is possible to utilize a uniform adjusting device 9 for the various adjusting means of the vehicle seat 1 shown in FIGS. 1 through 5.

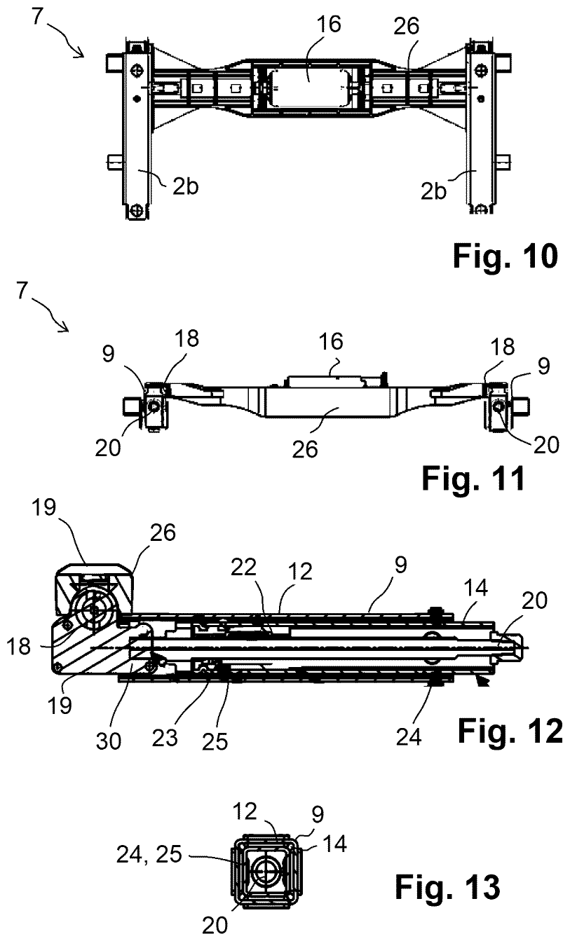

The adjusting devices 6, 8, 11 may be designed in accordance with various embodiments. To illustrate this, FIGS. 6 through 15 show an adjusting device 9 with an outer profile 12 and an inner profile 14 set into the outer profile 12. The profiles 12, 14 are preferably designed as closed profiles thereby exhibiting a high degree of stability; preferably, as shown here, they can be designed as square profiles. In-between the profiles a front sliding bushing 24 and a rear sliding bushing 25 are provided. The adjustment is carried out motor driven via an electromotive drive which is formed by an electric motor 16 and a downstream transmission 18, the transmission 18 driving or rotating respectively a spindle shaft 20, i.e., a thread leadscrew and/or a rod with threads. Advantageously, on each side a transmission housing 19 of the transmission 18 rests on the respective adjusting device 9, i.e., the transmission housing 19 forms an overlying gear box. The spindle shaft 20 is preferably mounted on or, respectively, in the inner profile and receives a threaded nut 22 with its threading which is received in the outer profile 12. Thus, the spindle shaft 20 is driven by the electric motor 16 and the transmission 18 and rotates so that the threaded nut 22 firmly received in the outer profile 12 runs on the spindle shaft 20 in a longitudinal direction thereby attaining the longitudinal adjustment of the inner profiles 14 in relation to the outer profile 12. The threaded nut 22 is firmly received in the outer profile 12, e.g., by positive locking and/or by crimping.

The spindle shaft 20 is received with its rear end in the transmission 18 driving it, and further to the front is mounted, e.g., in a spindle bearing 23 in the inner profile 14.

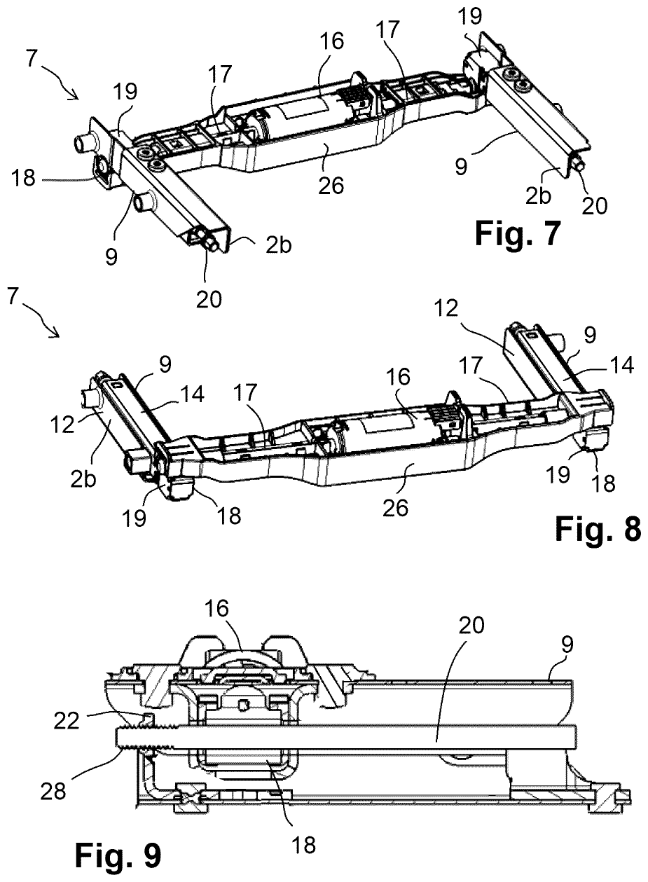

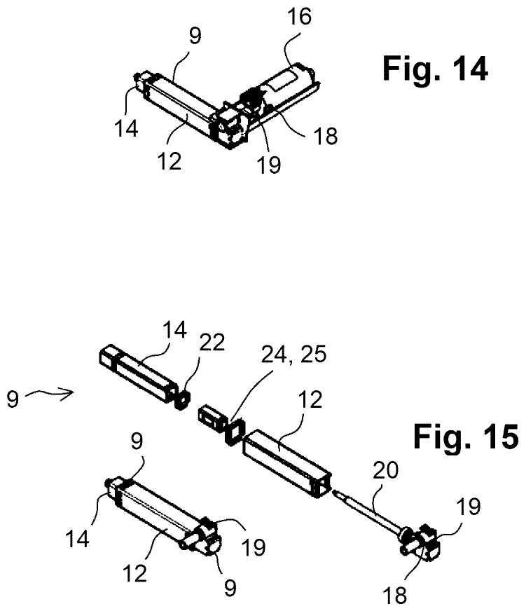

In the FIGS. 7 through 12 adjusting systems 7 are shown as bridge designs in which the central electric motor 16 is received in a cross bar 26 and drives two lateral, parallel adjusting devices 9 via two lateral transmissions 18. Hereby, the cross bar 26 with the electric motor 16, the two laterally protruding motor shafts 17 and the gears 18 may be arranged above or below the adjusting devices 9, as can be seen in FIG. 8 and FIG. 9. Thus, according to FIGS. 7, 8, 10 and 11, the electric motor 16 as a motor bridge can drive at both of its sides two adjusting devices 9; according to FIG. 14, however, the electric motor 16 may be driving merely one adjusting device 9. Thus, FIG. 7 preferably shows an adjusting system 7 made of two adjusting devices 9 and a motor bridge consisting of the cross bar 26, the electric motor 16, the two laterally protruding motor shafts 17 and the transmission 18.

FIG. 12 shows the connection of the spindle shaft 20 to its front threading in the threaded nut 22 of the outer profile 12, and a rear spindle rod receptacle 30 in the transmission 18 and thus firmly on the inner profile 14 so that these connecting points 28 and 30 are adjusted in relation to one another in a longitudinal direction. Thus, the forward and backward adjustments are both motor assisted, in contrast to, e.g., in the case of spring assisted restoring means. In principle, this already provides a self-locking adjustment means, because no adjustment of the profiles 12 and 14 in relation to one another is possible without active rotation of the spindle shaft 20.

FIGS. 12 and 13 show the arrangement of the sliding bushings 24, 25 between the profiles 12 and 14, as well as the receptacle of the spindle shaft 20 in a rear spindle rod receptacle 30 and a front spindle bearing 23 in the inner profile 14. The motor shafts 17 driven by the electric motor 16 may be designed, in particular, as so-called flexshafts.

Because adjustments are made only longitudinally and no bending moments or lateral forces of the spindle shaft 20 and the threaded nut 22 occur, it is possible to provide simple sliding bushings 24 and 25. Thus, ball bearings or other more complex bearings for withstanding higher forces and bending moments are not required.

The cross bar 26 with the electric motor 16 and the motor shafts 17 may be provided-depending on the desired adjustment—in suitable places, e.g., below the seat cushion 3; the telescopic adjusting devices 9 themselves may be designed compact, space-saving and with low weight.

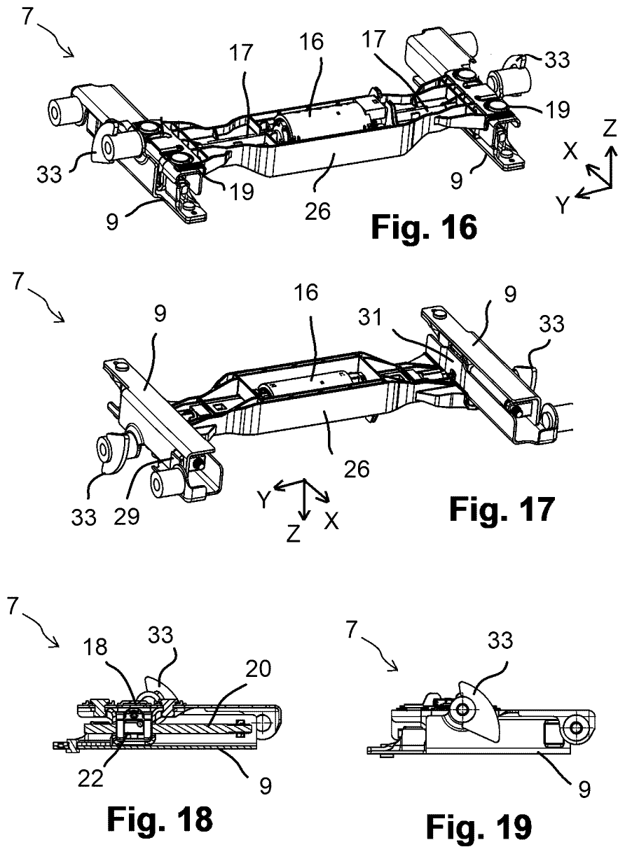

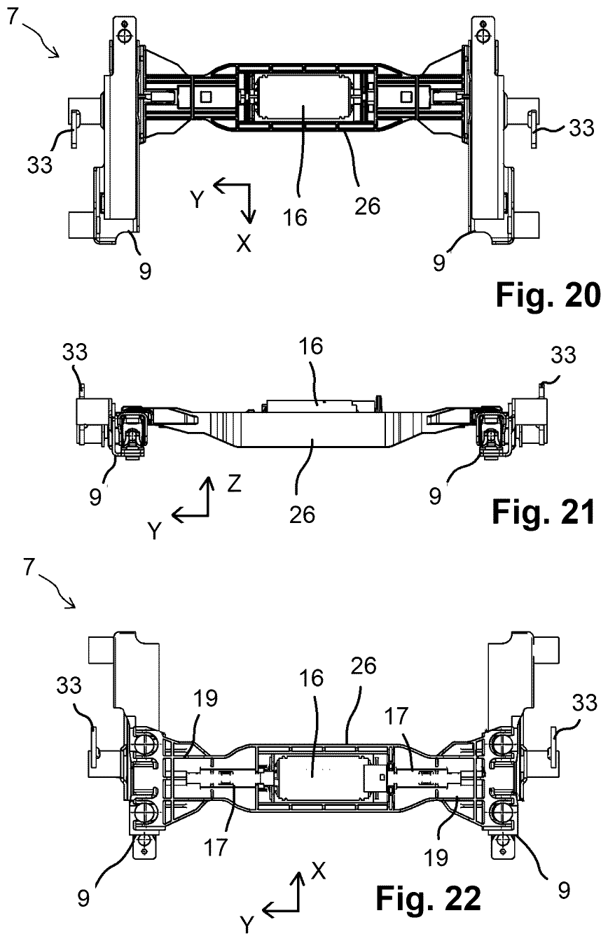

The FIGS. 16 through 22 show a further embodiment of an adjusting system 7 including two adjusting devices 9, using essentially the same images as the first embodiment of FIGS. 6 through 19. Hereby, in particular, the two transmission housings 19 of the cross bar 26 formed on the sides of the cross bar 26, which rest on the adjusting devices 9, are designed smaller in the vertical direction Z so as to form a smaller package in the vertical direction Z. To that end, advantageously, the transmission housings 19 are designed longer in a longitudinal direction X, as can be seen, in particular, in FIGS. 16 and 22

Further, a spindle mounting 29 is provided on the lateral, i.e. outer side in the lateral transverse direction Y of the profiles of the adjusting device 9, e.g., the lower profile of the adjusting device 9.

On the sides of the adjusting devices 9 anti-rotation stops 31 are provided to prevent rotation in the event of a crash because thy hold the transmission 18 or, respectively, the transmission housing 19 lateral to the or inside the profile, e.g., as an embossment or elevation respectively (e.g., embossment form).

Furthermore, for the event of a crash anti-rotation stoppers 33 are provided projecting sideways or laterally outwards in a direction Y from the profiles of the adjusting device 9 and holding the entire transmission mechanism as well as, advantageously, the entire adjusting system 7 preventing rotation during the crash.

Furthermore, advantageously, in this embodiment, the number of parts or components respectively is reduced, and, in particular, incorporated in a single fixed profile design.

Clause 1 Vehicle seat (1) for a vehicle, the vehicle seat (1) comprising:
a first seat part (3, 2a) being adjustable relative to a second seat part (2, 2b),
an adjusting device (9; 6, 8, 11) designed to adjust the first seat part (3, 2a) relative to the second seat part (2, 2b),
an electromotive drive (16, 18) for driving said adjusting device (9),
wherein said adjusting device (9) comprises a spindle shaft (20), which is preferably a thread leadscrew, a threaded nut (22) received on said spindle shaft (20), an outer profile (12), and an inner profile (14),
said inner profile (14) being longitudinally adjustable received in the outer profile (12), and one of said profiles being connected with said spindle shaft (20), and the other profile being connected with said threaded nut (22),
characterized in that
sliding bushings (24, 25) are provided in-between the profiles (12, 14).

Clause 2 Vehicle seat (1) according to clause 1, characterized in that
the electromotive drive (16, 18) comprises an electric motor (16) and a transmission (18) with a transmission housing (19),
said transmission housing (19) being mounted on said inner profile (14) and/or said threaded nut (22) being connected with said outer profile (12).

Clause 3 Vehicle seat (1) according to clause 2, characterized in that said transmission housing (19) and/or said threaded nut (22) are received in or on said profile (12, 14) by positive locking, in particular, by deforming or crimping of the profile (12, 14).

Clause 4 Vehicle seat (1) according to one of the above clauses, characterized in that said sliding bushings (24, 25) are provided on a front bearing position and a rear bearing position in-between the profiles (12, 14).

Clause 5 Vehicle seat (1) according to one of the above clauses, characterized in that said profiles (12, 14) are designed
as closed profiles, e.g., square profiles, in particular, for sliding bushings (24, 25) made of a plastic material, or
as open profiles, in particular, open square profiles.

Clause 6 Vehicle seat (1) according to one of the above clauses, characterized in that said adjusting device (9) is designed as a concentric arrangement of
said outer profile (12),
said inner profile (14),
said sliding bushings (24, 25) arranged in-between said inner profile (14) and said outer profile, and
said spindle shaft (20) with a threaded nut (22) arranged in said inner profile (14).

Clause 7 Vehicle seat (1) according to one of the above clauses, characterized in that the electromotive drive (16, 18) is arranged with its motor shaft (17) essentially orthogonal with respect to said profiles (12, 14) and said spindle shaft (20).

Clause 8 Vehicle seat (1) according to one of the above clauses, characterized in that said adjusting device (9) comprises exactly one outer profile (12) and one inner profile (14), in particular, as a single-track-adjusting device.

Clause 9 Vehicle seat (1) according to clause 1, 7 or 8, characterized in that two parallel adjusting devices (9) are provided,
the electromotive drive (16, 18) is received in or on a cross bar (26) extending perpendicular to said profiles (12, 14),
where said cross bar (26) together with the electromotive drive (16, 18) and the parallel adjusting devices (9) forms an adjusting system (17).

Clause 10 Vehicle seat (1) according to clause 9, characterized in that two parallel adjusting devices (9) are provided which are driven by the common electromotive drive (16, 18),
said cross bar (26) being provided as a motor bridge between said adjusting devices (9),
said electromotive drive (16, 18) driving, towards the two adjusting devices (9), one motor shaft each and/or a common motor shaft (17).

Clause 11 Vehicle seat (1) according to clause 10, characterized in that the transmission (18) is formed between the motor shaft (17) and the spindle shaft (20) on both sides by a lateral receptacle of the motor bridge advantageously resting on the lateral adjusting devices (9), in particular, their profiles.

Clause 12 Vehicle seat (1) according to clause 11, characterized in that imprints or stampings (31) are formed in said lateral profiles, in particular, to create anti rotation tabs, in particular, for fixing the transmission.

Clause 13 Vehicle seat (1) according to one of the clauses 9 through 12, characterized in that anti rotation stoppers (33) are each provided laterally outwards on said parallel adjusting devices (9) which are arranged such that in the case of a crash they prevent rotation of the adjusting system (7) and/or the adjusting devices (9), e.g., by resting against a stop on areas of the vehicle or the vehicle seat.

Clause 14 Vehicle seat (1) according to one of the above clauses, characterized in that said adjusting device (9) is provided between
a longitudinal track system (2), in particular, upper tracks (2a) of the longitudinal track system (2), and
a seat cushion (3) of the vehicle seat (1),
for adjusting a seat height and/or a seat inclination of the seat cushion (3) in relation to the longitudinal track system (2).

Clause 15 Vehicle seat (1) according to clause 14, characterized in that the following is provided between the longitudinal track system (2) and the seat part (3)
one pair of front adjusting devices (6), and
one pair of rear adjusting devices (8),
where an inclination of the seat cushion (3) can be adjusted by operating merely either the front adjusting devices (6) or the rear adjusting devices (8), and
a seat height of the seat cushion (3) in relation to the longitudinal track system (2) can be adjusted by operating the rear and front adjusting devices (6, 8).

Clause 16 Vehicle seat (1) according to one of the above clauses, characterized in that at least one adjusting device (9), in particular, one pair of adjusting devices (9), is provided between upper tracks (2a) of a longitudinal track system (2) and lower tracks (2b) of the longitudinal track systems (2) to be mounted on the floor inside the vehicle (1), for longitudinal adjustment of the vehicle seat (1).

Clause 17 Vehicle seat (1) according to one of the above clauses, characterized in that at least one adjusting device (11), in particular, one pair of adjusting devices (11), is provided between a seat cushion (3) and a foot rest (10) of the vehicle seat (1), for swivel adjustment of the foot rest (10).

1. A vehicle seat for a vehicle, the vehicle seat comprising:
a first seat part being adjustable relative to a second seat part,
an adjusting device configured to adjust said first seat part relative to said second seat part, and
an electromotive drive for driving said adjusting device,
wherein said adjusting device comprises a spindle shaft, a threaded nut received on said spindle shaft, an outer profile and an inner profile,
said inner profile being longitudinally adjustable received in said outer profile, and one of said profiles being connected with said spindle shaft, and said other profile being connected with said threaded nut,
wherein sliding bushings are provided in-between said profiles.

2. The vehicle seat according to claim 1, wherein:
said electromotive drive comprises an electric motor and a transmission with a transmission housing,
said transmission housing being mounted on said inner profile and/or said threaded nut being connected with said outer profile.

3. The vehicle seat according to claim 2, wherein said transmission housing and/or said threaded nut are received in or on said profile by positive locking.

4. The vehicle seat according to claim 1, wherein said sliding bushings are provided on a front bearing position and a rear bearing position in-between said profiles.

5. The vehicle seat according to claim 1, wherein said profiles are configured:
as closed profiles, or
as open profiles.

6. The vehicle seat according to claim 1, wherein said adjusting device is designed as a concentric arrangement of:
said outer profile,
said inner profile,
said sliding bushings arranged in-between said inner profile and said outer profile, and said spindle shaft with a threaded nut arranged in said inner profile.

7. The vehicle seat according to claim 1, wherein said electromotive drive is arranged with its motor shaft essentially orthogonal with respect to said profiles and said spindle shaft.

8. The vehicle seat according to claim 1, wherein said adjusting device comprises exactly one outer profile and one inner profile.

9. The vehicle seat according to claim 1, wherein said adjusting device is a first adjusting device and wherein the vehicle seat further comprising a second adjusting device in parallel with the first adjusting device, wherein:
said electromotive drive is received in or on a cross bar extending perpendicular to said profiles, and
said cross bar together with said electromotive drive and said parallel adjusting devices forms an adjusting system.

10. The vehicle seat according to claim 9, wherein the two parallel adjusting devices are driven by said common electromotive drive,
said cross bar being provided as a motor bridge between said adjusting devices,
said electromotive drive driving, towards said two adjusting devices, one motor shaft each and/or a common motor shaft.

11. The vehicle seat according to claim 10, wherein said transmission is formed between said motor shaft and said spindle shaft on both sides by a lateral receptacle of said motor bridge.

12. The vehicle seat according to claim 11, further comprising imprints or stampings ormed in said lateral profiles.

13. The vehicle seat according to claim 9, further comprising anti rotation stoppers located laterally outwards on said parallel adjusting devices which are arranged such that in the case of a crash they prevent rotation of said adjusting system and/or said adjusting devices.

14. The vehicle seat according to claim 1, wherein said adjusting device is located between:
a longitudinal track system, and
a seat cushion of said vehicle seat,
for adjusting a seat height and/or a seat inclination of said seat cushion in relation to said longitudinal track system.

15. The vehicle seat according to claim 14, further comprising one pair of front adjusting devices and one pair of rear adjusting devices located between said longitudinal track system and said seat part,
wherein an inclination of said seat cushion can be adjusted by operating either said front adjusting devices or said rear adjusting devices, and
a seat height of said seat cushion in relation to said longitudinal track system can be adjusted by operating said rear and front adjusting devices.

16. The vehicle seat according to claim 1, wherein said adjusting device is located between upper tracks of a longitudinal track system and lower tracks of said longitudinal track systems to be mounted on a floor inside said vehicle, for longitudinal adjustment of said vehicle seat.

17. The vehicle seat according to claim 1, wherein said adjusting device is located between a seat cushion and a foot rest of said vehicle seat, for swivel adjustment of said foot rest.
